(19) United States
(12) Patent Application Publication
(10) Pub. No.: US 2022/0245692 A1
(43) Pub. Date: Aug. 4, 2022

(54) MULTI-VARIANT OFFER GENERATION SYSTEM

(71) Applicant: eBay Inc., San Jose, CA (US)

(72) Inventor: Vikas Singh, San Jose, CA (US)

(21) Appl. No.: 17/165,386

(22) Filed: Feb. 2, 2021

(51) Int. Cl. G06Q 30/06

(52) U.S. Cl. CPC G06Q 30/0611

(57) ABSTRACT

Disclosed are systems, methods, and non-transitory computer-readable media for a multi-variant offers. An offer management system enables a buyer to submit a single multi-variant offer for multiple variants of an item. For example, the multi-variant offer submitted by the buyer may be accepted by a seller that is willing to provide the buyer with any one of the multiple variants of the item defined in the multi-variant offer for the offered purchase price. As the multi-variant offer is a single offer, the buyer does not have to be concerned with multiple offers being accepted as would be the case when sending individual offers for each variant of an item.

### TECHNICAL FIELD

An embodiment of the present subject matter relates generally to an online marketplace and, more specifically, to multi-variant offers.

### BACKGROUND

Online marketplace services allow users to buy and sell items. For example, these services enable users to post listings that offer items for sale, as well as view listings posted by other users. Some services allow users to submit offers for an item, such as by submitting an offered amount to purchase the item. One issue with current services is that buyers are limited to submitting an offer for a single variant of an item that is being offered for sale in the listing. In many cases, however, a seller may be flexible regarding certain aspects of the item. For example, a buyer that is primarily concerned with cost may be flexible regarding the color of the item if the item may be purchased for a desired price. As current systems limit offers to a single variant of the item (e.g., a single color), a buyer is not able to express that they are willing to accept multiple variants of the item. This is particularly problematic because submitting multiple concurrent offers places the buyer at risk of having multiple offers accepted. To avoid this possibility, the buyer must submit offers for different variants of an item sequentially, which is both time consuming and requires additional interactions with the online marketplace service. Accordingly, improvements are needed.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 shows a system for multi-variant otters in an online marketplace, according to some example embodiments.

FIG. 2 is a block diagram of the offer management system, according to some example embodiments.

FIGS. 3A and 3B show a buyer interface for submitting a multi-variant offer, according to some example embodiments.

FIG. 4 is a notification presenting a multi-variant offer, according to some example embodiments.

FIG. 5 is an acceptance notification indicating that a multi-variant offer has been accepted, according to some example embodiments.

FIG. 6 is a flowchart showing a method of providing a multi-variant offer, according to some example embodiments.

FIG. 7 is a block diagram illustrating a representative software architecture, which may be used in conjunction with various hardware architectures herein described.

FIG. 8 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

In the following description, for purposes of explanation, various details are set forth in order to provide a thorough understanding of some example embodiments. It will be apparent, however, to one skilled in the art, that the present subject matter may be practiced without these specific details, or with slight alterations.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

Disclosed are systems, methods, and non-transitory computer-readable media for multi-variant offers. An online marketplace service allows users to buy and sell items online. For example, the online marketplace service allows sellers to post a listing to an online marketplace that lists an item for sale. Buyers may view the listings to the online marketplace and purchase items. For example, a buyer may select to purchase an item for a sale price associated with the listing.

Additionally, the online marketplace service may utilize the functionality of an offer management system to enable users to submit offers for the listed items. For example, the offer management system enables a buyer to designate an offer price at which the buyer is wiling to purchase the listed item. The offer management system generates an offer based on the designated offer price, which is then submitted to the seller of the item for review. The seller may then choose to accept or deny the buyer's offer.

The offer management system may also enable the seller to submit a counteroffer to the buyer. For example, the offer management system enables the seller to designate a counteroffer price at which the seller is willing to sell the item. The offer management system generates a counteroffer based on the designated counteroffer price, which is then submitted to the buyer for review. The buyer may then choose to accept or deny the seller's counteroffer.

As explained earlier, current systems limit buyers to submitting offers for a single variant of an item. For example, some items may be available in multiple variants that have different aspects, such as a smartphone offered in multiple colors, memory sizes, screen sizes, and the like. A buyer, however, may be flexible regarding certain aspects if other specified criteria are met. For example, a buyer that is primarily concerned with the cost of an item may be flexible regarding other aspects of the item, such as the color, if the item may be purchased for a desired price. That is, the buyer may be willing to accept more than one of the variants of the items (e.g., accept any color of the item) if a specified price is met.

Limiting buyers to submitting offers for a single variant of an item is problematic because a buyer that is willing to accept multiple variants must submit individual offers for each variant. This can particularly problematic because submitting multiple concurrent offers places the buyer at risk of having multiple offers accepted. To avoid this possibility, the buyer must submit offers for the different variants sequentially, which is both time consuming and requires additional interactions with the online marketplace service. These additional interactions consume additional computing resources associated with accessing the online marketplace, identifying item, submitting offers, and the like.

To alleviate these issues, the offer management system enables a buyer to submit a single multi-variant offer for multiple variants of an item. For example, the multi-variant offer submitted by the buyer may be accepted by a seller that is willing to provide the buyer with any one of the multiple variants of the item defined in the multi-variant offer for the offered purchase price. As the multi-variant offer is a single offer, the buyer does not have to be concerned with multiple offers being accepted as would be the case when sending individual offers for each variant of an item.

The offer management system provides a buyer interface that enables buyers to generate multi-variant offers. For example, the buyer interface is a user interface that presents the buyer with multiple configurable aspects associated with an item and enables the buyer to select values for each of the aspects. The values selected by the buyer may define a single acceptable value for the aspect or, alternatively, indicate multiple acceptable values for the aspect. For example, a buyer that wants a specific color of an item may select a value to indicate the specific color that the buyer is willing to accept. Alternatively, a buyer that is flexible regarding the color of the time may select a value identifying a group of two or more colors that are acceptable to the buyer or that the user has no preference regarding color, meaning that the buyer is willing to accept any color of the item.

The buyer interface also enables the buyer to submit an offered price for the item. The offered price is a monetary value the buyer agrees to pay if the offer is accepted by the seller.

The offer management system uses the values and offered price provided by a buyer to generate a multi-variant offer for the item. For example, the offer management system uses the provided values to determine multiple variants of the item that the buyer is willing to accept for the offered price. The offer management system generates an offer identifying the determined variants of the item and the offered price, which is then transmitted to the seller of the item. The seller may then accept or deny the offer. Further, the seller may submit a counteroffer, such as by designating a counteroffer price for multiple variants of the item, a single variant of the item, and/or a variant of the item that was not included in the buyer's multi-variant offer.

Enabling buyers to generate multi-variant offers provides several improvements over existing systems. For example, multi-variant offers reduce the number of individual offers that are submitted because a single multi-variant offer may be used made in place of multiple individual offers for different variants of an item. This reduction in the number of submitted offers results in a reduction in overall computing resources associated with buyers browsing listings, accessing the buyer interface, generating offers, transmitting offers to sellers, cancelling subsequently submitted offers, and the like. Further, multi-variant offers eliminates the possibility of multiple concurrent offers submitted by a buyer for different variants of an item being accepted.

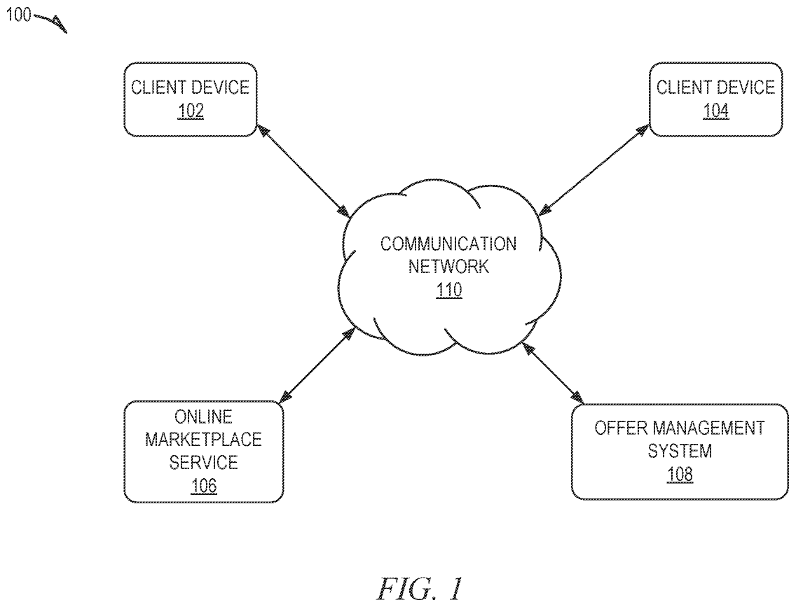

FIG. 1 shows a system 100 for multi-variant offers in an online marketplace, according to some example embodiments. As shown, multiple devices i.e., client device 102, client device 104, online marketplace service 106, and offer management system 108) are connected to a communication network 110 and configured to communicate with each other through use of the communication network 110. The communication network 110 is any type of network, including a local area network (LAN), such as an intranet, a wide area network (WAN), such as the internet, or any combination thereof. Further, the communication network 110 may be a public network, a private network, or a combination thereof. The communication network 110 is implemented using any number of communication links associated with one or more service providers, including one or more wired communication links, one or more wireless communication links, or any combination thereof. Additionally, the communication network 110 is configured to support the transmission of data formatted using any number of protocols.

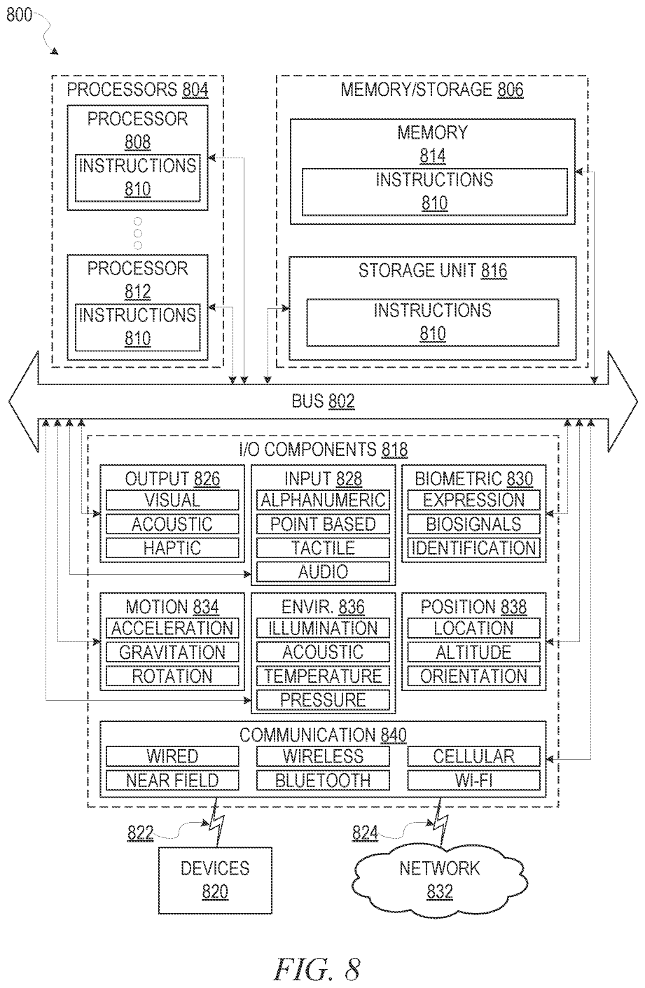

Multiple computing devices can be connected to the communication network 110. A computing device is any type of general computing device capable of network communication with other computing devices. For example, a computing device can be a personal computing device such as a desktop or workstation, a business server, or a portable computing device, such as a laptop, smart phone, or a tablet personal computer (PC). A computing device can include some or all of the features, components, and peripherals of the machine 800 shown in FIG. 8.

To facilitate communication with other computing devices, a computing device includes a communication interface configured to receive a communication, such as a request, data, and the like, from another computing device in network communication with the computing device and pass the communication along to an appropriate module running on the computing device. The communication interface also sends a communication to another computing device in network communication with the computing device.

In the system 100, users (e.g., sellers, buyers) interact with the online marketplace service 106 to utilize the services provided by the online marketplace service 106. The online marketplace service 106 provides an online marketplace where users may post items for sale and purchase items posted for sale by other users. For example, the online marketplace service 106 includes listings for items being auctioned for sale and/or items listed for sale at a set price. Users communicate with and utilize the functionality of the online marketplace service 106 by using the client devices 102 and 104 that are connected to the communication network 110 by direct and/or indirect communication.

Although the shown system 100 includes only two client devices 102, 104, this is only for ease of explanation and is not meant to be limiting. One skilled in the art would appreciate that the system 100 can include any number of client devices 102, 104. Further, the online marketplace service 106 may concurrently accept connections from and interact with any number of client devices 102, 104. The online marketplace service 106 supports connections from a variety of different types of client devices 102, 104, such as desktop computers; mobile computers; mobile communications devices, e.g., mobile phones, smart phones, tablets; smart televisions; set-top boxes; and/or any other network enabled computing devices. Hence, the client devices 102 and 104 may be of varying type, capabilities, operating systems, and so forth.

A user interacts with the online marketplace service 106 via a client-side application installed on the client devices 102 and 104. In some embodiments, the client-side application includes a component specific to the online marketplace service 106. For example, the component may be a stand-alone application, one or more application plug-ins, and/or a browser extension. However, the users may also interact with the online marketplace service 106 via a third-party application, such as a web browser, that resides on the client devices 102 and 104 and is configured to communicate with the online marketplace service 106. In either case, the client-side application presents a user interface (UI) for the user to interact with the online marketplace service 106, example, the user interacts with the online marketplace service 106 via a client-side application integrated with the file system or via a webpage displayed using a web browser application.

The online marketplace service 106 is one or more computing devices configured to facilitate an online marketplace (e.g., EBAY, AMAZON, etc.) where users may post items for sale and purchase items posted for sale by other users. For example, the online marketplace service 106 provides a user interface that enables users to view listings posted to the online marketplace service 106. Each listing provides details for an item or items listed for sale. For example, the listing may include an item description, images, sale price, current bid price, auction time remaining, shipping options, aspects, etc.

The online marketplace service 106 may further provide functionality that enables a user (e.g., buyer) to purchase and/or submit on offer to purchase an item. For example, the online marketplace service 106 may provide user interface elements (e.g., buttons, text fields, etc.) that a buyer may use to purchase an item, submit an offer, etc., as well as provide financial (e.g., credit card number, bank account number) and personal information (e.g., shipping address, billing address, etc.) to complete the purchase.

To list an item for sale on the online marketplace, a user (e.g., seller) creates a user account with the online marketplace service 106. The user account may include the seller's personal information (e.g., name, address, email address, phone number, etc.) and financial information (e.g., credit card information, bank account information, etc.). The seller can use the created user account to utilize the functionality of the online marketplace service 106, including listing an item for sale on the online marketplace.

The online marketplace service 106 provides sellers with a listing interface that enables sellers to create new listings as well as provide data for the listings. For example, the listing interface may include data fields that prompt the seller to provide specified information for the listing, such as the sale price, item description, listing title, images, shipping cost, return policy, aspects, etc. The listing interface may also include user interface elements, such as buttons, that enable the seller to submit and/or post a completed listing. That is, the seller may post the listing after the seller has filled in the data fields and provided images included in the listing interface.

The online marketplace service 106 utilizes the functionality of the offer management system 108 to provide multi-variant offers for items listed for sale on the online marketplace. A multi-variant offer is an offer to purchase any one of multiple specified variants of an item for an offered price. That is, the offer may be satisfied by a seller by providing the buyer any one of the variants of the item that are defined by the multi-variant offer. For example, a multi-variant offer that identifies multiple colors of an item that the buyer is willing to accept may be satisfied by the seller by providing the buyer with the item in any of the colors identified in the multi-variant offer. Although the offer management system 108 and the online marketplace service 106 are shown as two separate entities, this is just one possible embodiment and is not meant to be limiting. In some embodiments, the functionality of the offer management system 108 may be partially or completely integrated into the online marketplace service 106.

The offer management system 108 provides a buyer interface that enables buyers to generate multi-variant offers. For example, the buyer interface is a user interface that presents the buyer with multiple configurable aspects associated with an item and enables the buyer to select values for each of the aspects. The values selected by the buyer may define a single acceptable value for the aspect or, alternatively, indicate multiple acceptable values for the aspect. For example, a buyer that wants a specific color of an item may select a value to indicate the specific color that the buyer is willing to accept. Alternatively, a buyer that is flexible regarding the color of the time may select a value identifying a group of two or more colors that are acceptable to the buyer or that the user has no preference regarding color, meaning that the buyer is willing to accept any color of the item,

The buyer interface also enables the buyer to submit an offered price for the item. The offered price is a monetary value the buyer agrees to pay if the offer is accepted by the seller.

The offer management system 108 uses the values and offered price provided by a buyer to generate a multi-variant offer for the item. For example, the offer management system 108 uses the provided values to determine multiple variants of the item that the buyer is willing to accept for the offered price. The offer management system 108 generates an offer identifying the determined variants of the item and the offered price, which is then provided to the seller of the item. For example, the multi-variant offer may be transmitted to the seller as an email, direct message, push notification, and the like, which the seller may access using a client device 102, 104.

The seller may choose to accept or deny the multi-variant offer. example, the multi-variant offer may be presented along with user interface elements (e.g., buttons) that the seller may select from to accept the offer. As another example, the seller may use a client device 102, 104 to access the online marketplace service 106 to accept or deny the multi-variant offer. For example, the offer management system 108 may provide a seller interface that enables the seller to select to accept or deny the multi-variant offer, as well as identify the specific variant of the item that the seller will provide to the buyer.

A seller that rejects a multi-variant offer may submit a counteroffer to the buyer. For example, the seller interface may allow the seller to designate a counteroffer price at which the seller is willing to sell the item. The seller interface may also enable the seller to designate whether the counteroffer is based on the multiple variants of the item identified in the multi-variant offer, or a single variant of the item, and/or a variant of the item that was not included in the multi-variant offer. The offer management system 108 generates the counteroffer based on the data provided by the seller, which is then provided to the buyer of the item. For example, the counteroffer may be transmitted to the buyer as an email, direct message, push notification, and the like, which the buyer may access using a client device 102, 104.

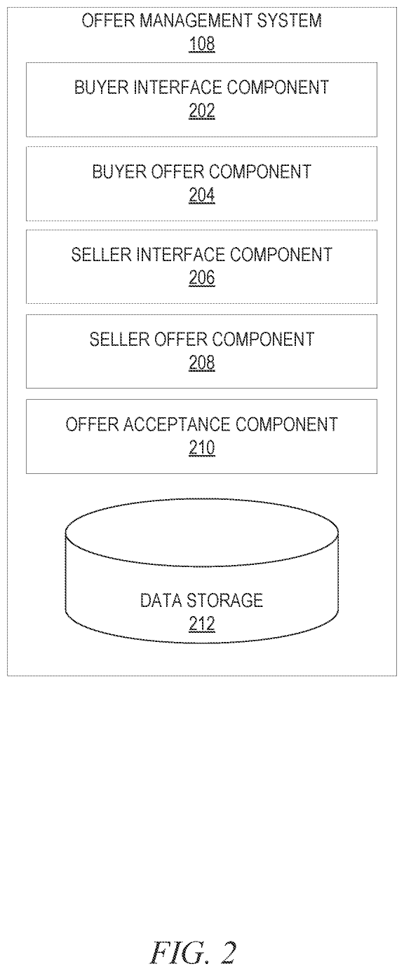

FIG. 2 is a block diagram of the offer management system 108, according to some example embodiments. To avoid obscuring the inventive subject matter with unnecessary detail, various functional components (e.g., modules) that are not germane to conveying an understanding of the inventive subject matter have been omitted from FIG. 2. However, a skilled artisan will readily recognize that various additional functional components may be supported by the offer management system 108 to facilitate additional functionality that is not specifically described herein. Furthermore, the various functional modules depicted in FIG. 2 may reside on a single computing device or may be distributed across several computing devices in various arrangements such as those used in cloud-based architectures. For example, the various functional modules and components may be distributed amongst computing devices that facilitate both the offer management system 108 and the online marketplace service 106.

As shown, the offer management system 108 includes a buyer interface component 202, a buyer offer component 204, a seller interface component 206, a seller offer component 208, an offer acceptance component 210, and a data storage 212.

The buyer interface component 202 provides a buyer interface that enables buyers to submit multi-variant offers. For example, the buyer interface may be presented in relation to a listing posted to an online marketplace. The buyer interface may present configurable aspects associated with an item and enable the buyer to select values for each of the aspects.

An aspect of an item is any type of variable descriptor for categorizing variants of an item. For example, an aspect of an item may be based on a manufacturer selectable feature or options associated with the item, such as the screen size, color, available memory, transmission type, and the like. An aspect may also be based on a status of the item, such as whether the item is new or used, a number of miles that have been driven, a current condition of the item (e.g., excellent, average, poor), and the like. An aspect of the item may also be based on conditions related to purchasing the item, such as whether the item can be delivered or picked up locally, a delivery cost, whether the cost of delivery is included, whether tax is applicable to the purchase, an expected delivery date, and the like.

The buyer interface presents the various available aspects for a given listing and enables users to provide values for the presented aspects. The values define the variants of the item that the buyer is offering to purchase. For example, the buyer may enter a value (e.g., blue, red) indicating the color of the item that the buyer is willing to accept. As another example, the buyer may enter a value indicating a condition of the item (e.g., new, used, excellent) that the buyer is willing to accept.

The buyer may define an individual value for an aspect, such as a specific color (e.g., blue) or condition (e.g., new), or may define multiple acceptable values for an aspect. For example, the buyer may define multiple colors (e.g., blue, red) or conditions (e.g., new, used) which the buyer is willing to accept as part of the offer.

In some embodiments, the buyer may user the buyer interface to indicate that the buyer is willing to accept any value for the aspect. For example, a buyer that is willing to accept any color of an item may use the buyer interface that the buyer is willing to accept any color value of the item. The buyer interface may enable a buyer to select or enter a value indicating that the buyer is willing to accept any value. As another example, the buyer interface may allow a buyer to leave the value undefined (e.g., a value is not entered/selected) to indicate that any value of as aspect is acceptable.

The buyer interface component 202 may determine the aspects and available values for a given item based on data stored in the data storage 212. For example, a listing of aspects and values may be stored in the data storage 212 and associated with the item, listing, and/or seller. Accordingly, the buyer interface component 202 may access the data storage 212 to access the data defining the aspects and values corresponding to an item being viewed by a buyer. The buyer interface component 202 may cause presentation of the aspects and value to the buyer in the buyer interface, which may be presented to the buyer as part of the listing for the item.

In addition to enabling a buyer to select values for the various aspects of an item, the buyer interface may also enable a buyer to enter an offer price for the multi-variant offer. The offer price is a value (e.g., monetary value) that the buyer is offering to pay in exchange for the item as defined by the multi-variant offer. For example, the buyer interface may allow the buyer to enter in a number defining the offer price.

The buyer interface also enables the buyer to submit a multi-variant offer based on the values and offer price selected by the buyer. For example, the buyer interface may include a user interface, such as a button, that the buyer may select or otherwise actuate to submit the multi-variant offer.

The buyer interface component 202 may provide data indicating the values and offer price selected by a buyer to the other components of the offer management system 108. For example, the buyer interface component 202 may provide the data to the buyer offer component 204.

The buyer offer component 204 uses the data to generate a multi-variant offer. For example, the buyer offer component 204 uses the values received from the buyer interface component 202 to determine variants of the item that the buyer is willing to accept as part of the offer. The buyer offer component 204 may generate a multi-variant offer that indicates the variants of the item as well as identifies the offer price submitted by the buyer.

The buyer offer component 204 may provide the generated multi-variant offer to the seller of the item. For example, the buyer offer component 204 may transmit the multi-variant offer to the seller as an email, direct message, push notification, and the like, which the seller may access using a client device 102, 104. The seller may to choose to accept or deny the multi-variant offer. For example, the seller interface component 206 provides a seller interface that enables the seller to view and respond to a multi-variant offer.

The seller interface may present the multi-variant offer such as by presenting the offered price provided by the buyer as well as identifying the variants of the item that the buyer is willing to accept. The seller interface may include user interface elements, such as buttons, that enable the seller to select from accepting or denying the multi-variant offer. Additionally, the seller interface may enable the seller to submit a counteroffer. For example, the seller interface may enable the seller to enter a counteroffer price at which the seller is willing to sell the item.

A counteroffer may be for a single variant or multi-variants of an item. For example, the seller interface may enable the seller to select a specific variant of the item for the counteroffer or select multiple variants of the item.

The seller offer component 208 submits a counteroffer to the buyer. For example, the seller offer component 208 may transmit the counteroffer to the buyer as an email, direct message, push notification, and the like, which the buyer may access using a client device 102, 104. The buyer may to choose to accept or deny the counteroffer.

The offer acceptance component 210 performs functionality associated with an accepted offer. This includes acceptance of a multi-variant offer submitted by a buyer and a counteroffer submitted by the seller. For example, the offer acceptance component 210 may provide notifications to the buyer and/or seller indicating that a multi-variant offer or counteroffer has been accepted. The notification may include data identifying the accepted offer price and/or variant of the item. The offer acceptance component 210 may also update data in the data storage to indicate that the multi-variant offer was accepted. The offer acceptance component 210 may also enable the buyer to submit payment for the item. For example, the offer acceptance component 210 may provide an interface that allows the buyer to submit payment information, such as credit card or bank information, to provide payment for the item.

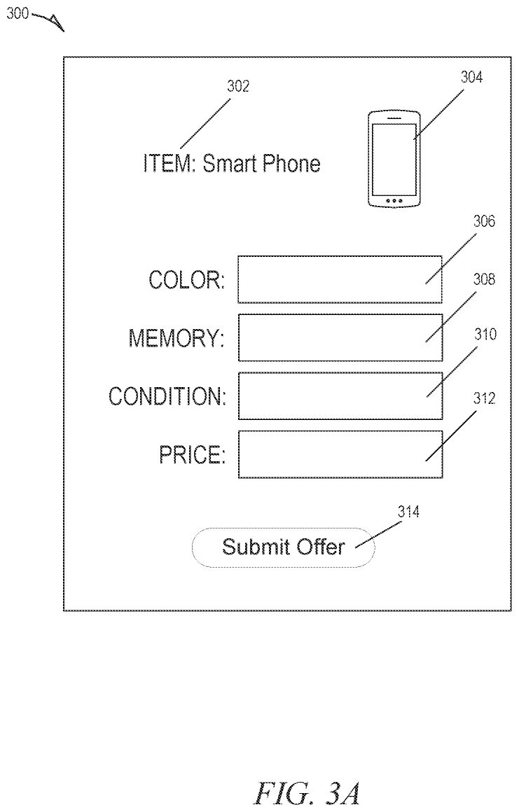

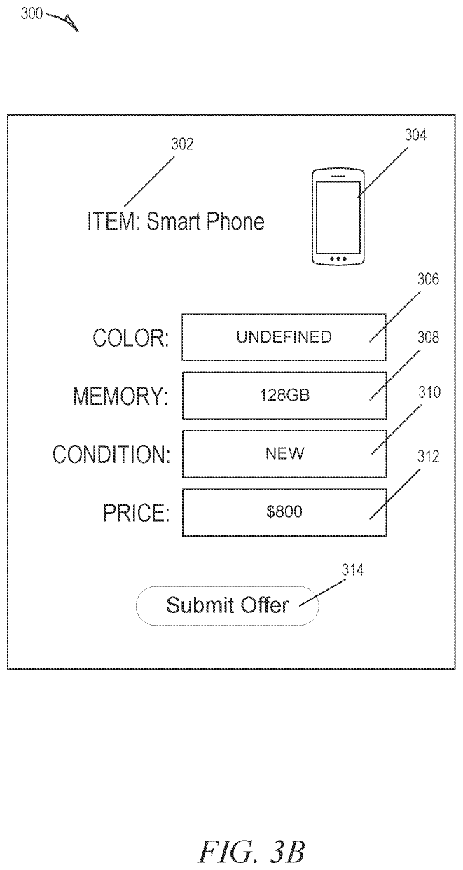

FIGS. 3A and 3B show a buyer interface 300 for submitting a multi-variant offer, according to some example embodiments. As shown in FIG. 3A, the buyer interface 300 includes an item description 302 and an image 304 identifying that a smart phone is being offered for sale. The buyer interface 300 lists various configurable aspects of the item, such as the color, memory and condition. A buyer may user the buyer interface 300 to select values for the listed aspects. For example, the buyer interface 300 includes a color text field 306 for selecting a value for the color aspect of the smart phone. The buyer may enter a value into the color text field 306 indicating the color or colors of the smart phone that the buyer is willing to accept. Similarly, the buyer interface includes a memory text field 308 and condition text field 310 that enable the buyer to select values for the memory aspect and condition aspect of the smart phone.

The buyer interface 300 also includes a price text field 312 that enables the buyer to select an offer price at which the buyer is willing to purchase the selected variants of the smart phone in a multi-variant offer. The buyer interface 300 also includes a submit button 314 that enables a buyer to submit a multi-variant offer. For example, the buyer may click or otherwise actuate the submit button 314 after providing values for some or all of the listed aspects of the smart phone.

FIG. 3B shows the buyer interface 300 with values provided for the presented aspects. As shown, the value “undefined” has been entered in the color text field 306. The undefined value may indicate that the buyer is flexible regarding the color of the smart phone and is therefore willing to accept any color given that the values specified for the other aspects of the item are met. For example, the value “128 GB” has been entered in the memory text field 308 to indicate that the buyer is willing to accept a variant of the smart phone that has 128 Gigabits (GB) of memory or, in some embodiments, at least 128 GB of memory. Similarly, the value “new” has been entered into the condition text field 310 to indicate that the buyer is willing to accept the smart phone in only new condition, rather than used, as part of the offer.

The value “$800” has been entered into the price text field 312 to indicate that the buyer is offering to pay $800 for any variant of the smart phone that meets the aspect value provided by the buyer. For example, the buyer is offering to pay $800 to purchase the smart phone in any available color, with at least 128 GB of memory, and in new condition. A seller may accept the buyer's multi-variant offer with any variant of the smart phone as defined by the multi-variant offer. For example, a seller may accept the offer with a new smart phone that blue and has 128 GB of memory or, alternatively, a new smart phone that is black and has 256 GB of memory.

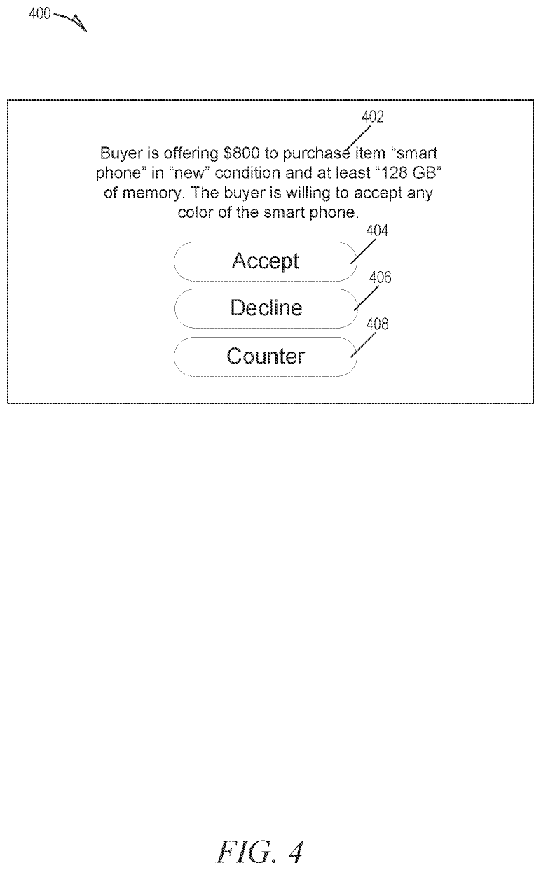

FIG. 4 is a notification 400 presenting a multi-variant offer, according to some example embodiments. As shown, the notification 400 includes a text description 402 describing the terms of the multi-variant offer submitted by the buyer. As shown, the text description 402 indicates that the buyer is offering to pay an offer price of $800 for a smart phone in new condition, with at least 128 GB of memory and in any color. The notification 400 includes an accept button 404, a decline button 406, and a counter button 408. The accept button 404 enables the seller to accept the multi-variant offer. For example, the seller may click or otherwise actuate the accept button 404 to accept the multi-variant offer.

Similarly, the decline button 406 enables the seller to decline the offer. For example, the seller may click or otherwise actuate the decline button 406 to decline the multi-variant offer. The counter button 408 enables the seller to submit a counteroffer to the multi-variant offer. Submitting a counteroffer declines the multi-variant offer and submits a new offer to the buyer based on terms selected by the seller.

Selection of the counter button 408 may cause the seller to be presented with a seller interface that is similar to the buyer interface 300 shown in FIGS. 3A and 3B. For example, the seller interface may enable the seller to enter a counteroffer price, as well as select values for various aspects of the item, such as the color, memory, and condition. This may allow a seller to generate a counteroffer based on variants of the item that the seller has in inventory.

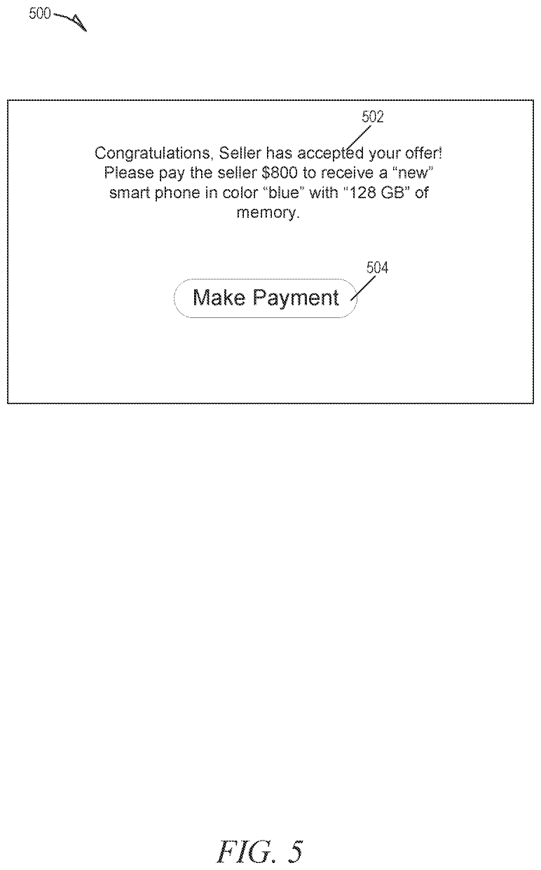

FIG. 5 is an acceptance notification 500 indicating that a multi-variant offer has been accepted, according to some example embodiments. The acceptance notification 500 may be presented to a buyer after a multi-variant offer has been accepted. As shown, the acceptance notification 500 includes a text portion 502 indicating that the multi-variant offer has been accepted. The text portion 502 also described the finalized conditions of the accepted multi-variant offer by indicating that the buyer is to pay $800 to the seller, and in return the buyer will provide the seller with a new smartphone in the color “blue” with 128 GB of memory.

The acceptance notification 500 also includes a payment button 504 that enables the buyer to submit payment for the item. For example, the buyer may select or otherwise actuate the payment button 504 to cause presentation of a payment interface that allows the buyer to enter their payment information. This may include entering credit card and/or bank information to provide the seller with payment for the item.

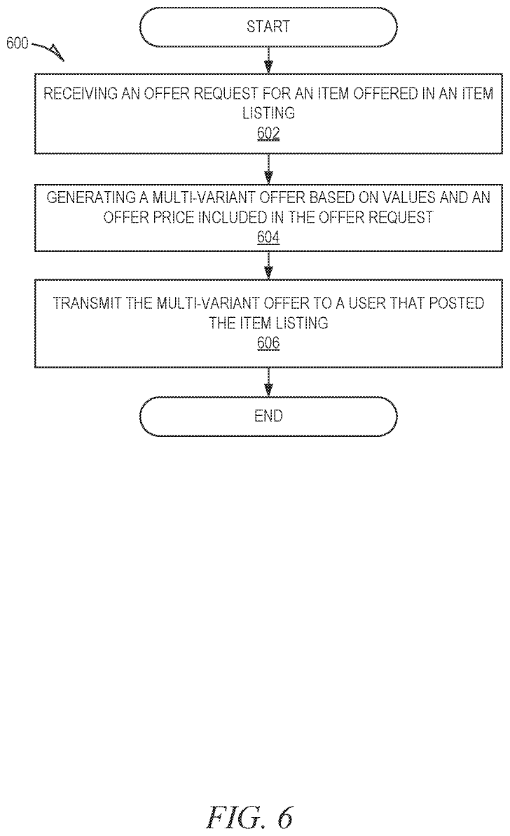

FIG. 6 is a flowchart showing a method 600 of providing a multi-variant offer, according to some example embodiments. The method 600 may be embodied in computer readable instructions for execution by one or more processors such that the operations of the method 600 may be performed in part or in whole by the offer management system 108; accordingly, the method 600 is described below by way of example with reference thereto. However, it shall be appreciated that at least some of the operations of the method 600 may be deployed on various other hardware configurations and the method 600 is not intended to be limited to the offer management system 108.

At operation 602, the buyer interface component 202 receives an offer request for an item offered in an item listing. The buyer interface component 202 provides a buyer interface that enables buyers to submit multi-variant offers. For example, the buyer interface may be presented in relation to a listing posted to an online marketplace. The buyer interface may present configurable aspects associated with an item and enable the buyer to select values for each of the aspects.

The buyer interface includes user interface elements that enable the buyer to select values for the various aspects as well as select an offer price. The buyer interface includes a submit button that the buyer may use to submit the multi-variant offer. Selection of the submit button causes transmission of the offer request from the client device 102 of the buyer, which is received by the buyer interface component 202. The request may include the values for the various aspects provided by the buyer, as well as the offer price provided by the buyer.

At operation 604, the buyer offer component 204 generates a multi-variant offer based on values and an offer price included in the offer request. For example, the buyer offer component 204 uses the values received from the buyer interface component 202 to determine variants of the item that the buyer is willing to accept as part of the offer. The buyer offer component 204 may generate a multi-variant offer that indicates the variants of the item as well as identifies the offer price submitted by the buyer.

At operation 606, the buyer offer component 204 transmits the multi-variant offer to a user that posted the item listing. The buyer offer component 204 may provide the generated multi-variant offer to the seller of the item. For example, the buyer offer component 204 may transmit the multi-variant offer to the seller as an email, direct message, push notification, and the like, which the seller may access using a client device 102, 104. The seller may to choose to accept or deny the multi-variant offer. For example, the seller interface component 206 provides a seller interface that enables the seller to view and respond to a multi-variant offer.

### Software Architecture

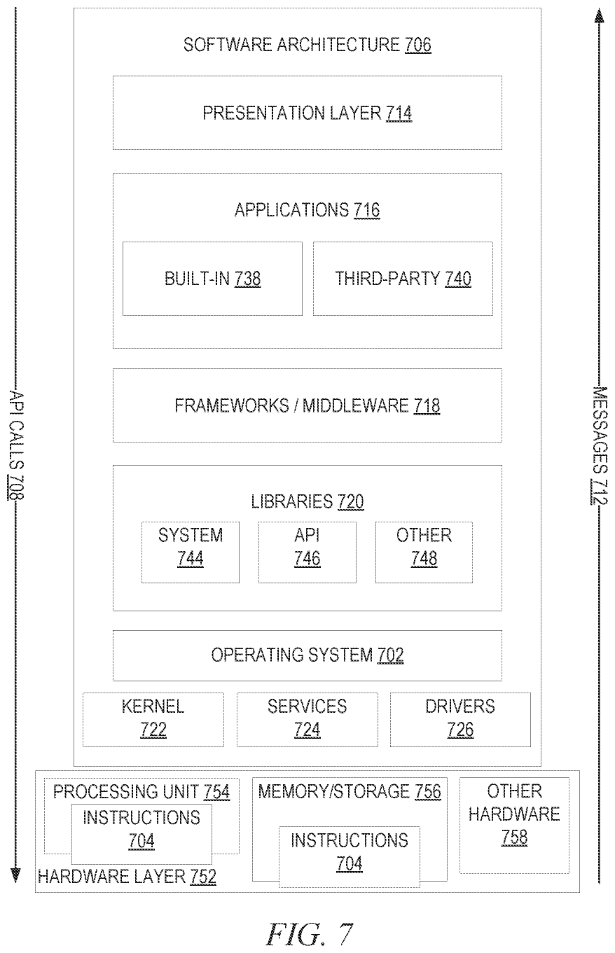

FIG. 7 is a block diagram illustrating an example software architecture 706, which may be used in conjunction with various hardware architectures herein described. FIG. 7 is a non-limiting example of a software architecture 706 and it will be appreciated that many other architectures may be implemented to facilitate the functionality described herein. The software architecture 706 may execute on hardware such as machine 800 of FIG. 8 that includes, among other things, processors 804, memory 814, and (input/output) I/O components 818. A representative hardware layer 752 is illustrated and can represent, for example, the machine 800 of FIG. 8. The representative hardware layer 752 includes a processing unit 754 having associated executable instructions 704. Executable instructions 704 represent the executable instructions of the software architecture 706, including implementation of the methods, components, and so forth described herein. The hardware layer 752 also includes memory and/or storage modules 756, which also have executable instructions 704. The hardware layer 752 may also comprise other hardware 758.

In the example architecture of FIG. 7, the software architecture 706 may be conceptualized as a stack of layers where each layer provides particular functionality. For example, the software architecture 706 may include layers such as an operating system 702, libraries 720, frameworks/middleware 718, applications 716, and a presentation layer 714. Operationally, the applications 716 and/or other components within the layers may invoke Application Programming Interface (API) calls 708 through the software stack and receive a response such as messages 712 in response to the API calls 708. The layers illustrated are representative in nature and not all software architectures have all layers. For example, some mobile or special purpose operating systems may not provide a frameworks/middleware 718, while others may provide such a layer. Other software architectures may include additional or different layers.

The operating system 702 may manage hardware resources and provide common services. The operating system 702 may include, for example, a kernel 722, services 724, and drivers 726. The kernel 722 may act as an abstraction layer between the hardware and the other software layers. For example, the kernel 722 may be responsible for memory management, processor management (e.g., scheduling), component management, networking, security settings, and so on. The services 724 may provide other common services for the other software layers. The drivers 726 are responsible for controlling or interfacing with the underlying hardware. For instance, the drivers 726 include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 720 provide a common infrastructure that is used by the applications 716 and/or other components and/or layers. The libraries 720 provide functionality that allows other software components to perform tasks in an easier fashion than to interface directly with the underlying operating system 702 functionality (e.g., kernel 722, services 724, and/or drivers 726). The libraries 720 may include system libraries 744 (e.g., C standard library) that may provide functions such as memory allocation functions, string manipulation functions, mathematical functions, and the like. In addition, the libraries 720 may include API libraries 746 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 720 may also include a wide variety of other libraries 748 to provide many other APIs to the applications 716 and other software components/modules.

The frameworks/middleware 718 (also sometimes referred to as middleware) provide a higher-level common infrastructure that may be used by the applications 716 and/or other software components/modules. For example, the frameworks/middleware 718 may provide various graphical user interface (GUI) functions, high-level resource management, high-level location services, and so forth. The frameworks/middleware 718 may provide a broad spectrum of other APIs that may be used by the applications 716 and/or other software components/modules, some of which may be specific to a particular operating system 702 or platform.

The applications 716 include built-in applications 738 and/or third-party applications 740. Examples of representative built-in applications 738 may include, but are not limited to, a contacts application, a browser application, a book reader application, a location application, a media application, a messaging application, and/or a game application. Third-party applications 740 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 740 may invoke the API calls 708 provided by the mobile operating system (such as operating system 702) to facilitate functionality described herein.

The applications 716 may use built in operating system functions (e.g., kernel 722, services 724, and/or drivers 726), libraries 720, and frameworks/middleware 718 to create UIs to interact with users of the system. Alternatively, or additionally, in some systems, interactions with a user may occur through a presentation layer, such as presentation layer 714. In these systems, the application/component “logic” can be separated from the aspects of the application/component that interact with a user.

FIG. 8 is a block diagram illustrating components of a machine 800, according to some example embodiments, able to read instructions 704 from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 810 (e.g., software, a program, an application, an applet, an app, or other executable code) for causing the machine 800 to perform any one or more of the methodologies discussed herein may be executed. As such, the instructions 810 may be used to implement modules or components described herein. The instructions 810 transform the general, non-programmed machine 800 into a particular machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 800 capable of executing the instructions 810, sequentially or otherwise, that specify actions to be taken by machine 800. Further, while only a single machine 800 is illustrated, the term “machine” shall also be taken to include a collection of machines that individually or jointly execute the instructions 810 to perform any one or more of the methodologies discussed herein.

The machine 800 may include processors 804, memory/storage 806, and I/O components 818, which may be configured to communicate with each other such as via a bus 802. The memory/storage 806 may include a memory 814, such as a main memory, or other memory storage, and a storage unit 816, both accessible to the processors 804 (e.g., processor 808, processor 812) such as via the bus 802. The storage unit 816 and memory 814 store the instructions 810 embodying any one or more of the methodologies or functions described herein. The instructions 810 may also reside, completely or partially, within the memory 814, within the storage unit 816, within at least one of the processors 804 (e.g., within the processor's cache memory), or any suitable combination thereof, during execution thereof by the machine 800. Accordingly, the memory 814, the storage unit 816, and the memory of processors 804 are examples of machine-readable media.

The I/O components 818 may include a wide variety of components to receive input, provide output, produce output, transmit information, exchange information, capture measurements, and so on. The specific I/O components 818 that are included in a particular machine 800 will depend on the type of machine. For example, portable machines such as mobile phones will likely include a touch input device or other such input mechanisms, while a headless server machine will likely not include such a touch input device. It will be appreciated that the I/O components 818 may include many other components that are not shown in FIG. 8. The I/O components 818 are grouped according to functionality merely for simplifying the following discussion and the grouping is in no way limiting. In various example embodiments, the I/O components 818 may include output components 826 and input components 828. The output components 826 may include visual components (e,g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 828 may include alphanumeric input components (e.g., a keyboard, a touch screen configured to receive alphanumeric input, a photo-optical keyboard, or other alphanumeric input components), point based input components (e,g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 818 may include biometric components 830, motion components 834, environmental components 836, or position components 838 among a wide array of other components. For example, the biometric components 830 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 834 may include acceleration sensor components (e.g., accelerometer), gravitation sensor components, rotation sensor components (e.g., gyroscope), and so forth. The environmental components 836 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 838 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 818 may include communication components 840 operable to couple the machine 800 to a network 832 or devices 820 via coupling 824 and coupling 822, respectively. For example, the communication components 840 may include a network interface component or other suitable device to interface with the network 832. In further examples, communication components 840 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 820 may be another machine or any of a wide variety of peripheral devices (e.g., a peripheral device coupled via a USB).

Moreover, the communication components 840 may detect identifiers or include components operable to detect identifiers. For example, the communication components 840 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components microphones to identify tagged audio signals). In addition, a variety of information may be derived via the communication components 840, such as, location via Internet Protocol (IP) geo-location, location via Wi-Fi® signal triangulation, location via detecting a NFC beacon signal that may indicate a particular location, and so forth.

### Glossary

“CARRIER SIGNAL” in this context refers to any intangible medium that is capable of storing, encoding, or carrying instructions 810 for execution by the machine 800, and includes digital or analog communications signals or other intangible medium to facilitate communication of such instructions 810. Instructions 810 may be transmitted or received over the network 832 using a transmission medium via a network interface device and using any one of a number of well-known transfer protocols.

“CLIENT DEVICE” in this context refers to any machine 800 that interfaces to a communications network 832 to obtain resources from one or more server systems or other client devices. A client device 102, 104 may be, but is not limited to, mobile phones, desktop computers, laptops, PDAs, smart phones, tablets, ultra books, netbooks, laptops, multi-processor systems, microprocessor-based or programmable consumer electronics, game consoles, STBs, or any other communication device that a user may use to access a network 832.

“COMMUNICATIONS NETWORK” in this context refers to one or more portions of a network 832 that may be an ad hoc network, an intranet, an extranet, a virtual private network (VPN), a LAN, a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network 832 or a portion of a network 832 may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions 810 and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store instructions 810. The term “machine-readable medium” shall also be taken to include any medium, or combination of multiple media, that is capable of storing instructions 810 (e.g., code) for execution by a machine 800, such that the instructions 810, when executed by one or more processors 804 of the machine 800, cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors 804) may be configured by software (e.g., an application 716 or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor 804 or other programmable processor 804. Once configured by such software, hardware components become specific machines 800 (or specific components of a machine 800) uniquely tailored to perform the configured functions and are no longer general-purpose processors 804. It will be appreciated that the decision to implement a hardware component mechanically, in dedicated and permanently configured circuitry, or in temporarily configured circuitry (e.g., configured by software may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g, programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor 804 configured by software to become a special-purpose processor, the general-purpose processor 804 may be configured as respectively different special-purpose processors (e.g., comprising different hardware components) at different times. Software accordingly configures a particular processor or processors 804, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses 802) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors 804 that are temporarily configured (e.g., by software) or permanently configured to perform the relevant operations. Whether temporarily or permanently configured, such processors 804 may constitute processor-implemented components that operate to perform one or more operations or functions described herein. As used herein, “processor-implemented component” refers to a hardware component implemented using one or more processors 804. Similarly, the methods described herein may be at least partially processor-implemented, with a particular processor or processors 804 being an example of hardware. For example, at least some of the operations of a method may be performed by one or more processors 804 or processor-implemented components. Moreover, the one or more processors 804 may also operate to support performance of the relevant operations in a “cloud computing” environment or as a “software as a service” (SaaS). For example, at least some of the operations may be performed by a group of computers (as examples of machines 800 including processors 804), with these operations being accessible via a network 832 (e.g., the Internet) and via one or more appropriate interfaces (e.g., an API). The performance of certain of the operations may be distributed among the processors 804, not only residing within a single machine 800, but deployed across a number of machines 800. In some example embodiments, the processors 804 or processor-implemented components may be located in a single geographic location (e.g., within a home environment, an office environment, or a server farm). In other example embodiments, the processors 804 or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands,” “op codes,” “machine code,” etc.) and which produces corresponding output signals that are applied to operate a machine 800. A processor 804 may be, for example, a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC) or any combination thereof A processor may further be a multi-core processor having two or more independent processors 804 (sometimes referred to as “cores”) that may execute instructions 810 contemporaneously.

What is claimed is:

1. A method comprising:
receiving, from a client device, an offer request for an item offered in an item listing, the offer request including an offer price and data indicating that a first aspect of the item was undefined;
generating an offer for the item based on the offer price and the first aspect of the item was undefined, the offer being to purchase at least a first variant of the first item and second variant of the first item for the offer price, the first aspect of the first variant of the first item being different than the first aspect of the second variant of the first item; and
transmitting the offer to a user that, posted the item listing.

2. The method of claim 1, wherein the offer request further includes a selected value for a second aspect of the item, the second aspect of the first variant of the first item matching the second aspect of the second variant of the first item.

3. The method of claim 1, further comprising:
receiving a counteroffer to sell the first variant of the item for a revised offer price; and
providing the counteroffer to a user that provided the offer request.

4. The method of claim 3, wherein the counteroffer further offers to sell the second variant of the item for the revised offer price.

5. The method of claim 1, further comprising:
receiving an acceptance to the offer, the acceptance identifying the first variant of the item.

6. The method of claim 2, further comprising:
receiving a counteroffer to sell a third variant of the item, the second aspect of the third variant of the first item being different than the second aspect of the first variant of the first item and the second aspect of the second variant of the first item.

7. The method of claim 6, further comprising:
providing the counteroffer to a user that provided the offer request.

8. A system comprising:
one or more computer processors; and
one or more computer-readable mediums storing instructions that, when executed by the one or more computer processors, cause the system to perform operations comprising:
receiving, from a client device, an offer request for an item offered in an item listing, the offer request including an offer price and data indicating that a first aspect of the item was undefined;
generating an offer for the item based on the offer price and the first aspect of the item was undefined, the offer being to purchase at least a first variant of the first item and second variant of the first item for the offer price, the first aspect of the first variant of the first item being different than the first aspect of the second variant of the first item; and
transmitting the offer to a user that posted the item listing.

9. The system of claim 8, wherein the offer request further includes a selected value for a second aspect of the item, the second aspect of the first variant of the first item matching the second aspect of the second variant of the first item.

10. The system of claim 8, the operations further comprising:
receiving a counteroffer to sell the first variant of the item for a revised offer price; and
providing the counteroffer to a user that provided the offer request.

11. The system of claim 10, wherein the counteroffer further offers to sell the second variant of the item for the revised offer price.

12. The system of claim 8, the operations further comprising:
receiving an acceptance to the offer, the acceptance identifying the first variant of the item.

13. The system of claim 9, the operations further comprising:
receiving a counteroffer to sell a third variant of the item, the second aspect of the third variant of the first item being different than the second aspect of the first variant of the first item and the second aspect of the second variant of the first item.

14. The system of claim 13, the operations further comprising:
providing the counteroffer to a user that provided the offer request.

15. A non-transitory computer-readable medium storing instructions that, when executed by one or more computer processors of one or more computing devices, cause the one or more computing devices to perform operations comprising:
receiving, from a client device, an offer request for an item offered in an item listing, the offer request including an offer price and data indicating that a first aspect of the item was undefined;
generating an offer for the item based on the offer price and the first aspect of the item was undefined, the offer being to purchase at least a first variant of the first item and second variant of the first item for the offer price, the first aspect of the first variant of the first item being different than the first aspect of the second variant of the first item; and
transmitting the offer to a user that posted the item listing.

16. The non-transitory computer-readable medium of claim 15, wherein the offer request further includes a selected value for a second aspect of the item, the second aspect of the first variant of the first item matching the second aspect of the second variant of the first item.

17. The non-transitory computer-readable medium of claim 15, the operations further comprising:
receiving a counteroffer to sell the first variant of the item for a revised offer price; and
providing the counteroffer to a user that provided the offer request.

18. The non-transitory computer-readable medium of claim 17, wherein the counteroffer further offers to sell the second variant of the item for the revised offer price.

19. The non-transitory computer-readable medium of claim 15, the operations further comprising:
receiving an acceptance to the offer, the acceptance identifying the first variant of the item.

20. The non-transitory computer-readable medium of claim 16, the operations further comprising:
receiving a counteroffer to sell a third variant of the item, the second aspect of the third variant of the first item being different than the second aspect of the first variant of the first item and the second aspect of the second variant of the first item; and
providing the counteroffer to a user that provided the offer request.
